(19) United States
(12) Patent Application Publication
(10) Pub. No.: US 2025/0005735 A1
(43) Pub. Date: Jan. 2, 2025

(54) IMAGE ANALYSIS APPARATUS, CONTROL METHOD FOR IMAGE ANALYSIS APPARATUS, AND STORAGE MEDIUM

(71) Applicant: CANON KABUSHIKI KAISHA, Tokyo (JP)

(72) Inventor: SHOGO HAGIWARA, Kanagawa (JP)

(21) Appl. No.: 18/740,917

(22) Filed: Jun. 12, 2024

(30) Foreign Application Priority Data
Jun. 27, 2023 (JP) 2023-105341

(51) Int. Cl. G06T 7/00

(52) U.S. Cl. CPC G06T 7/0004

(57) ABSTRACT

An image analysis apparatus that analyzes an image of an inspection target, comprising: a selection unit configured to select a folder; and an analysis unit configured to analyze an image inside the folder selected by the selection unit based on a caption setting applied to the folder.

### BACKGROUND OF THE INVENTION

### Field of the Invention

The present invention relates to an image analysis apparatus, a control method for the image analysis apparatus, and a storage medium, and especially to an image analysis technique to detect a defect from an image obtained by shooting an inspection target.

### Description of the Related Art

There is a method in which a defect such as a crack is detected by a computer apparatus performing machine learning with respect to an image obtained by shooting an inspection target such as a wall surface of a concrete structure, and an attribute of the defect, like the width of the crack, is detected through image analysis.

International Publication No. 2017/168737 discloses a system in which, when displaying the position of a defect detected from an image, such as a crack, by superimposing the same on the image, emphasized display processing is executed to categorize the width of the crack based on value ranges and to use different colors depending on the category thereof, and captions that respectively correspond to the plurality of categories of crack widths are displayed.

Here, during an operation of inspection of an infrastructure, there are a case where the adopted categorization based on crack widths and color rendering vary depending on the type of a concrete structure, such as a tunnel and a bridge, and a case were categorization of crack widths and rendering colors are designated by a party that has ordered the operation of inspection.

However, according to the technique described in International Publication No. 2017/168737, it is necessary to individually perform, for example, categorization of a crack width that varies depending on the type of a structure and an ordering party when executing the image analysis; this places a burden on a user.

### SUMMARY OF THE INVENTION

The present disclosure has been made in view of the foregoing problem, and provides a technique to alleviate a load at the time of image analysis.

According to one aspect of the present invention, there is provided an image analysis apparatus that analyzes an image of an inspection target, comprising: a selection unit configured to select a folder; and an analysis unit configured to analyze an image inside the folder selected by the selection unit based on a caption setting applied to the folder.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of an image analysis apparatus according to a first embodiment.

FIG. 2 is a functional block diagram of the image analysis apparatus according to the first embodiment.

FIG. 3 is a diagram exemplarily showing a list screen according to the first embodiment.

FIG. 4 is a diagram exemplarily showing a folder creation screen according to the first embodiment.

FIG. 5 is a diagram exemplarily showing an analysis result list screen according to the first embodiment.

FIG. 6 is a diagram exemplarily showing an analysis result viewing screen according to the first embodiment.

FIG. 7A and FIG. 7B are diagrams illustrating a method of calculating actual size information according to the first embodiment.

FIG. 8 is a flowchart showing processing for executing image analysis according to the first embodiment.

FIG. 9 is a diagram exemplarily showing an image analysis method selection screen according to a second embodiment.

FIG. 10 is a diagram exemplarily showing a caption setting generation screen according to the first embodiment.

FIG. 11 is a diagram exemplarily showing data files according to the first embodiment.

FIG. 12 is a flowchart showing processing for viewing image analysis results according to the first embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In a first embodiment, a computer apparatus operates as an image analysis apparatus, and the image analysis apparatus, which detects a defect in an inspection target by analyzing an image obtained by shooting the inspection target, manages a plurality of images on a per-folder basis. Also, a caption setting is applied to each folder. A user can select a folder, and the image analysis apparatus analyzes images inside the selected folder based on the caption setting applied to the selected folder. Then, the analysis result is provided (e.g., displayed) using the caption setting applied to the selected folder. In this way, the setting can be applied to all of the images inside the folder; this can alleviate the user's trouble of configuring the setting when analyzing each individual image and providing the image analysis result.

Note that a defect according to the present embodiment denotes a defect that occurs on a concrete surface, such as a crack, due to such factors as a damage and deterioration of a concrete structure like a road that is exclusively for automobiles, a bridge, a tunnel, a dam, or the like. A crack denotes a line-like damage which occurs on, for example, a wall surface of a structure due to deterioration caused by aging, an earthquake-induced shock, or the like, and which has a start point, an end point, a length, and a width.

### Hardware Configuration

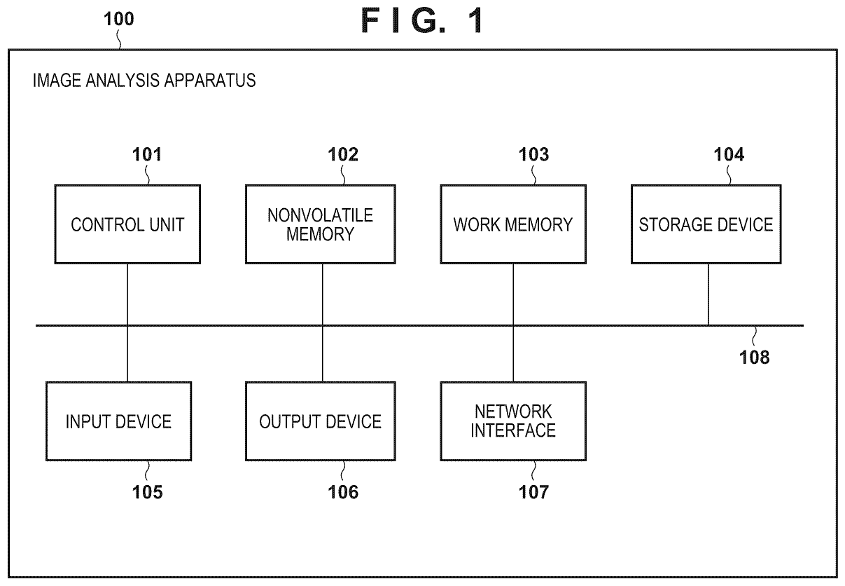

First, a hardware configuration of an image analysis apparatus according to the first embodiment will be described with reference to FIG. 1. In the present embodiment, a computer apparatus operates as an image analysis apparatus 100. Note that processing of the image analysis apparatus according to the present embodiment may be realized by a single computer apparatus, or may be realized by a plurality of computer apparatuses sharing discrete functions as necessary. In this case, the plurality of computer apparatus may be connected in such a manner that they can communicate with one another.

The image analysis apparatus 100 includes a control unit 101, a nonvolatile memory 102, a working memory 103, a storage device 104, an input device 105, an output device 106, a network interface 107, and a system bus 108.

The control unit 101 includes a computation processing processor, such as a central processing unit (CPU) and a micro processing unit (MPU), that performs integrated control on the entire image analysis apparatus 100. The nonvolatile memory 102 is a read-only memory (ROM) that stores a program executed by the processor of the control unit 101 and parameters. The program mentioned here denotes a program for executing processing according to embodiments. The working memory 103 is a random-access memory (RAM) that temporarily stores the program and data supplied from, for example, an external apparatus.

The storage device 104 is an internal device built in the image analysis apparatus 100, such as a hard disk and a memory card, or an external device that is connected to the image analysis apparatus 100 in an attachable and removable manner, such as a hard disk and a memory card. The storage device 104 includes, for example, a memory card and a hard disk composed of a semiconductor memory, a magnetic disk, or the like. Furthermore, the storage device 104 includes a storage medium composed of a disk drive that reads out/writes data from/to an optical disc such as a digital versatile disc (DVD) and a Blue-ray disc.

The input device 105 is an operation member, such as a mouse, a keyboard, and a touch panel, for accepting a user operation, and outputs an operation instruction to the control unit 101. The input device 105 functions as an acceptance unit that accepts a user operation. The output device 106 is a display apparatus, such as a display and a monitor, composed of a liquid crystal display (LCD) or an organic electro luminescence (EL). The output device 106 displays data held by the image analysis apparatus 100, and data supplied from an external device. The network interface 107 is connected to a network such as the Internet and a local area network (LAN) in a communication-enabled manner. The system bus 108 includes an address bus, a data bus, and a control bus that connect discrete constituent elements of the image analysis apparatus 100 in such a manner that data can be exchanged thereamong.

An operating system (OS), which is basic software executed by the control unit 101, and applications that realize applicative functions in coordination with this OS are recorded in the nonvolatile memory 102. Furthermore, in the present embodiment, an application that allows the image analysis apparatus 100 to realize later-described image analysis processing for detecting a defect from an image obtained by shooting an inspection target is stored in the nonvolatile memory 102.

Processing of the image analysis apparatus 100 according to the present embodiment is realized by reading in software provided by the applications. Note, it is assumed that the applications include software for using the basic functions of the OS installed on the image analysis apparatus 100. Note, the OS of the image analysis apparatus 100 may include software for realizing processing according to the present embodiment.

### Functional Configuration

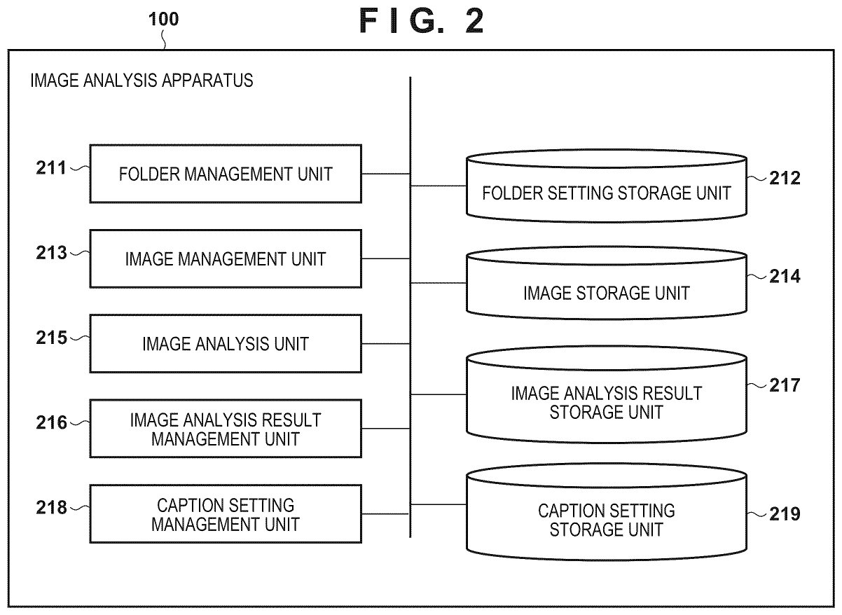

Next, a functional configuration of the image analysis apparatus according to the first embodiment will be described with reference to FIG. 2. The image analysis apparatus 100 includes a folder management unit 211, a folder setting storage unit 212, an image management unit 213, an image storage unit 214, an image analysis unit 215, an analysis result management unit 216, an analysis result storage unit 217, a caption setting management unit 218, and a caption setting storage unit 219. Each function of the image analysis apparatus 100 is composed of hardware and/or software. Note that each functional unit may be composed of one or more computer apparatuses and server apparatuses, and be configured as a system connected via a network.

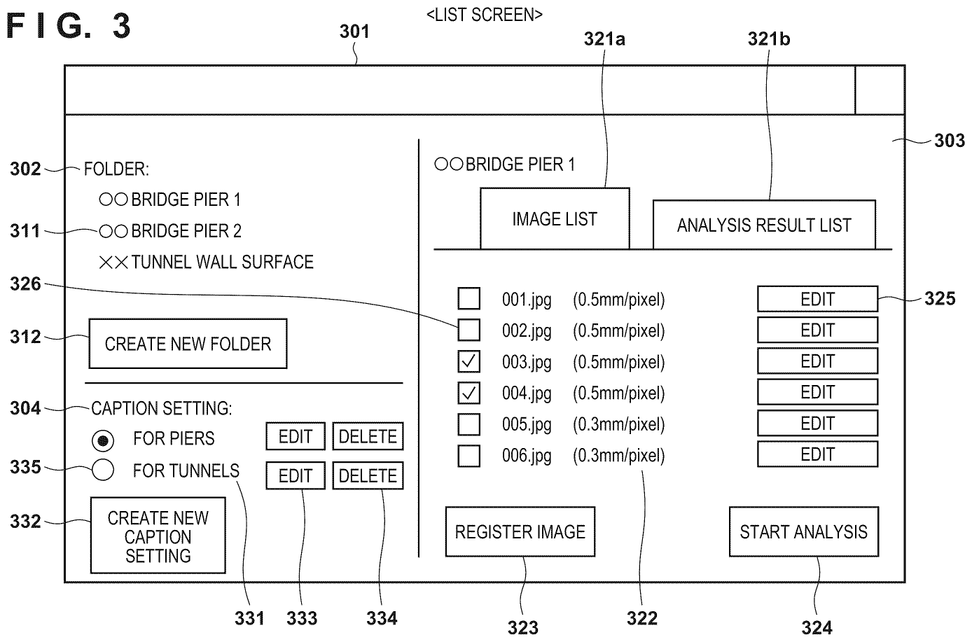

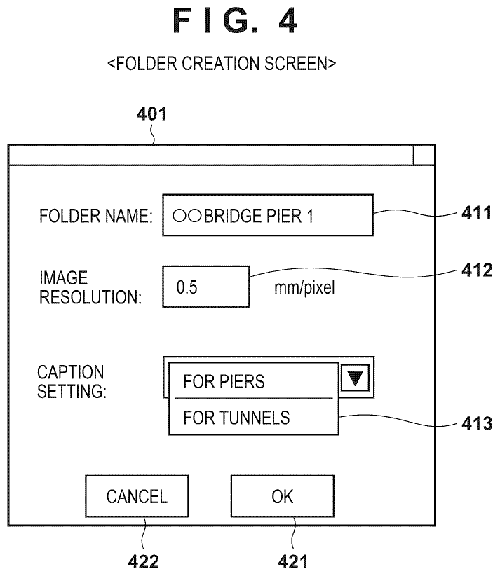

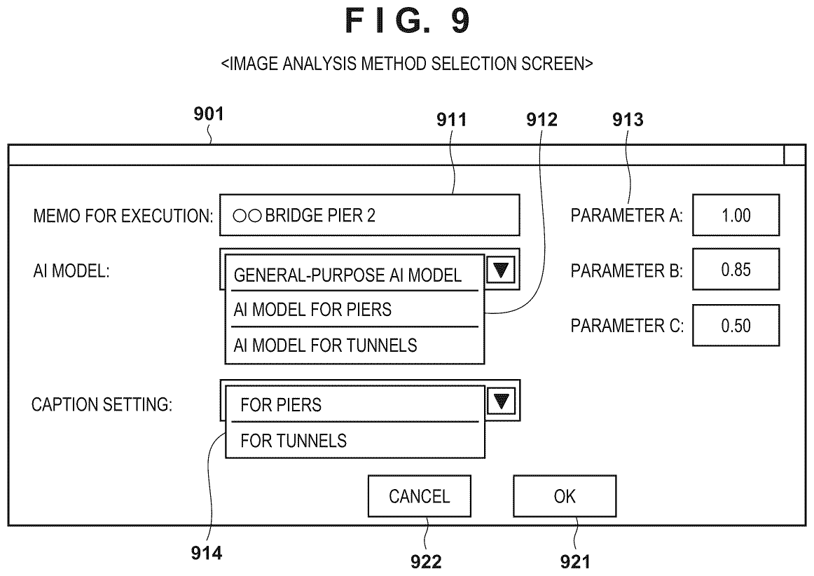

The folder management unit 211 has a function of, for example, creating, setting, and deleting folders and displaying a list of folders. The folder setting storage unit 212 has a function of storing settings of folders. The folder management unit 211 presents, to a user, a list screen that will be described later with reference to FIG. 3, a folder creation screen that will be described later with reference to FIG. 4, and an image analysis method selection screen that will be described later with reference to FIG. 9.

When creating a folder, the user inputs settings of the folder, such as a folder name, an image resolution, and a caption setting, on the folder creation screen. The folder creation screen may further include an item of a memo field for accepting a text input from the user. Alternatively, the folder creation screen may include information of the creation date/time, the access date time, and the like for folder management. The image resolution is the equivalent of information of an actual size per image pixel, or more specifically, a value of an actual size (e.g., mm) per image pixel, and is an image-to-actual size ratio (mm/pixel) indicating a ratio between a pixel and a value of an actual size.

Actual size information is also referred to as the equivalent of an actual size of an image, the resolution, the value of an actual size of a pixel, the value of an actual size of an image, or the like, in addition to the image-to-actual size ratio. An image does not include actual size information; in view of this, there are a method in which the user manually inputs actual size information, a method in which an estimation is made based on the size of a defect whose actual size information is apparent in an image, a method in which actual size information is obtained at the same time as shooting with use of another range-finding device, and so forth. The present embodiment will be described using the method in which the user manually inputs actual size information, as will be described later.

The caption setting includes a setting for viewing of an image analysis result. The setting for viewing includes a setting of a rendering element for display of a defect that has been detected through image analysis. Especially, in a case where detected defects are cracks, it is possible to categorize them into a plurality of levels in accordance with the values of the thicknesses of the crack widths, and to set the content of the rendering element for displaying the cracks with emphasis in distinction from other levels on a per-level basis. For example, various representations such as line types and rendering colors can be used as the rendering element for emphasized display. The present embodiment will be described using a method in which emphasized display is performed with rendering colors, as will be described later.

Furthermore, the caption setting includes an image analysis condition corresponding to the type of a structure to be inspected. For example, in a case where the structure is a pier, the caption setting can include an image analysis condition “for piers”. Also, in a case where the structure is a tunnel, the caption setting can include an image analysis condition “for tunnels”. For example, a model “for piers” or a model “for tunnels” can be set as an AI model to be applied.

The image management unit 213 has a function of storing images, registering images with folders, deleting images, displaying a list, viewing, changing an image resolution, changing a file name, and so forth. The image storage unit 214 stores data and settings of images. The image management unit 213 manages a plurality of images by registering them with folders. When storing an image, the user designates one folder with which the image is to be registered. The image management unit 213 configures a setting to apply an image resolution set by the user to images that has been registered with a folder designated by the user. The image storage unit 214 stores settings of images that have been registered with folders.

In order to detect a defect from an image which is managed in a folder and which has been obtained by shooting an inspection target, the image analysis unit 215 executes image analysis with use of a learning model that has been generated through machine learning and deep learning of artificial intelligence (AI). The analysis result storage unit 217 stores image analysis results.

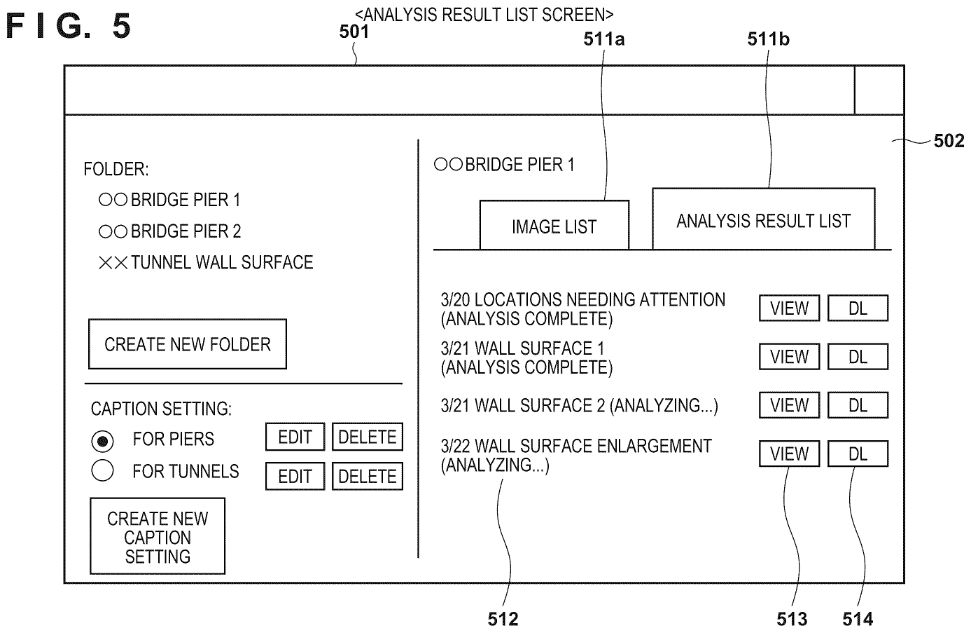

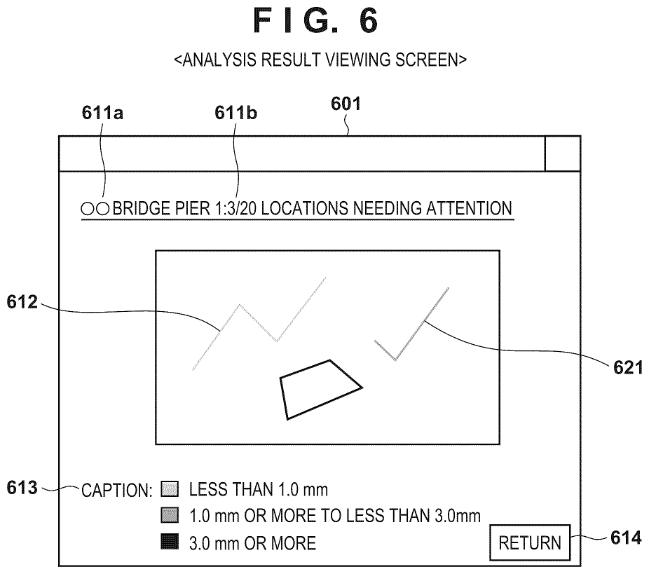

The analysis result management unit 216 has a function of, for example, viewing and obtaining the image analysis results stored in the analysis result storage unit 217. The analysis result management unit 216 presents an analysis result list screen that will be described later with reference to FIG. 5, an analysis result viewing screen that will be described later with reference to FIG. 6, and the like to the user.

The caption setting management unit 218 has a function of creating, editing, and deleting caption settings, displaying a list of caption settings, viewing and storing caption settings, applying caption settings to folders and image analysis, and so forth. The caption setting storage unit 219 stores data and settings of caption settings.

### Workflow for Detecting Defect

The following describes, as the premise of the present embodiment, an example of a workflow for a case where a defect is detected from an image obtained by shooting an inspection target. In the present embodiment, a defect is detected by performing image analysis using a learning model with respect to an image obtained by shooting a wall surface of a concrete structure with a camera.

In a case where an inspection target is shot on site, the entire range of the inspection target can be rarely captured within a single image at an image resolution that is sufficient to enable detection of a defect. Therefore, normally, the task of shooting a close-up of a part of the inspection target range is repeated while gradually changing the shooting range by moving. Then, after image processing such as enlargement, reduction, rotation, projective transformation, color adjustment, and noise removal has been applied to a plurality of images that have been shot in this way, one composite image is generated by piecing together the plurality of images to which the image processing has been applied.

Such a task is repeatedly performed in accordance with the number of components of a plan of an inspection target; for example, in the case of a pier which constitutes a bridge and which has a quadrilateral cross-section, such a task is repeatedly performed with respect to four side surfaces thereof, and consequently, a set of four images is prepared for “the Great ○○ Bridge, Pier 1”. A standard image resolution of a plan (e.g., 0.5 mm/pixel for bridges, and 2.0 mm/pixel for tunnels) is determined for each inspection target, and shooting is performed to satisfy this condition. Note that in a case where an intensive inspection is performed, shooting may be performed to achieve high-definition images. Thereafter, a composite image is generated in such a manner that the resolutions and positions of the plan are consistent; in this way, the preparation of an image for performing image analysis is complete.

Note that unlike a method in which a defect is manually recorded while viewing images, there is a possibility that a defect detected through the later-described image analysis contains erroneous detections and missed detections. For this reason, visual confirmation and correction are performed by displaying images on the image analysis apparatus or an external server. For example, in a case where a defect is a crack, an analysis result is generated in which the crack is superimposed on a plan or an image and a supplementary note indicating the length and width of the crack is added.

### List Screen and Folder Creation Screen

Next, a list screen and a folder creation screen according to the present embodiment will be described with reference to FIG. 3 and FIG. 4. FIG. 3 is a diagram exemplarily showing a list screen according to the present embodiment. A list screen 301 shown in FIG. 3 includes a folder list area 302, an image list area 303, and a caption setting list area 304. Hereinafter, especially the list screen 301 that displays the image list area 303 may be referred to as an image list screen.

In the folder list area 302, the folder names of folders that have already been created are displayed while being lined up in a predetermined order (e.g., in the order of folder names or creation dates/times), and a new folder creation button 312 is also displayed. When the user has selected a desired folder from the folder list 311, an image list 322 registered with the selected folder is displayed in the image list area 303. In the image list area 303, image files registered with the desired folder that has been selected by the user at will from the folder list 311 displayed in the folder list area 302 are displayed while being lined up in a predetermined order (e.g., in the order of file names or creation dates/times).

Also, the image list area 303 displays an image list tab 321a, an analysis result list tab 321b, an image registration button 323, and an analysis start button 324. The image list tab 321a is a button for displaying, in the image list area 303, the image files registered with the folder selected from the folder list area 302. The analysis result list tab 321b is a button for displaying, in the image list area 303, the analysis results of the image files registered with the folder selected from the folder list area 302.

Furthermore, in the caption setting list area 304, a caption setting list 331 that can be selected at the time of creation of a folder, which will be described later, is displayed while being lined up in a predetermined order (e.g., in the order of names of caption settings or creation dates/times), and a new caption setting generation button 332 is also displayed. Moreover, caption setting edit buttons 333 and caption setting delete buttons 334 are displayed for the caption settings displayed in the caption setting list 331 in the caption setting list area 304 to allow corresponding caption settings to be edited or deleted. In addition, default caption setting change buttons 335 are displayed for the caption settings displayed in the caption setting list 331 to allow for a change in the initial selection of a caption setting at the time of creation of a folder, which will be described later.

In a case where the user is to newly create a folder, the user operates the new folder creation button 312. Also, in a case where the user is to register image files with a folder, the user operates the image registration button 323. Furthermore, in a case where image analysis is to be executed, the analysis start button 324 is operated in a state where a folder has been selected.

In addition, in a case where the folder list 311 does not include a desired folder when image files are to be registered with a folder, the user can newly create a folder by operating the new folder creation button 312. Once the new folder creation button 312 has been operated, a folder creation screen 401 shown in FIG. 4 is displayed.

Next, FIG. 4 is a diagram exemplarily showing the folder creation screen according to the present embodiment. The folder creation screen 401 includes a folder name input field 411, an image resolution input field 412, a caption setting selection field 413, an OK button 421, and a cancel button 422.

The user inputs a title that allows an inspection target to be easily distinguished, such as the name of the inspection target, to the folder name input field 411, and inputs an image resolution to be applied to images registered with the folder to the image resolution input field 412. Also, the user selects a caption setting to be applied to analysis and viewing of the images registered with the folder from the caption setting selection field 413. For example, in a case where a caption setting for piers has been selected, image analysis and viewing of the analysis results for piers can be performed in accordance with this caption setting. Similarly, in a case where a caption setting for tunnels has been selected, image analysis and viewing of the analysis results for tunnels can be performed in accordance with this caption setting. Immediately after the folder creation screen 401 has been displayed, the initial selection value in the caption setting selection field 413 is the caption setting selected via the default caption setting change buttons 335. In a case where a change is necessary, one of the caption settings generated on a caption setting generation screen 1001, which will be described later, can be changed by operating the caption setting selection field 413.

The OK button 421 is a button for deciding on the folder name input to the folder name input field 411, the image resolution input to the image resolution input field 412, and the caption setting selected from the caption setting selection field 413, and for storing the settings of the folder. The cancel button 422 is a button for cancelling the folder name input to the folder name input field 411, the image resolution input to the image resolution input field 412, and the caption setting selected from the caption setting selection field 413, and for returning to the list screen 301.

Once the image registration button 323 in the image list area 303 on the list screen 301 of FIG. 3 has been operated, a screen for prompting the user to select images to be registered with the folder is displayed (not shown). By setting the image resolution to be applied to images with respect to the folder with which the images are to be registered, the user can apply the image resolution that has been set for the folder at the time of image registration to every image registered with the folder. The image files displayed in the image list 322 are accompanied by supplementary notes indicating the image resolutions that are currently applied or the image resolutions that have been changed.

Also, edit buttons 325 are displayed next to the image files displayed in the image list 322; in response to pressing of the edit buttons 325, the file names and image resolutions of corresponding image files can be edited. Furthermore, checkboxes 326 are displayed for the image files displayed in the image list 322. When the user has operated the analysis start button 324 after checking desired image files, a screen for accepting an input of a memo for the execution of analysis is displayed. Here, the memo for the execution is, for example, information of a supplementary note that the user can input at will, such as information of the date/time of the execution of image analysis, an inspected region, a warning level of an inspection target, and the like. In this way, after the input of the memo has been accepted as necessary, image analysis is executed with respect to the image files for which the checkboxes 326 have been checked.

Once the analysis result list tab 321b in the image list area 303 on the list screen 301 of FIG. 3 has been operated, an analysis result list screen 501 shown in FIG. 5 is displayed. By providing an image resolution to a learning model used in image analysis as one of parameters, image analysis appropriate for the actual size information of the defect is executed, and an improvement in the detection accuracy can be expected compared to a case where the image resolution is not designated. The analysis result list screen 501 will be described later with reference to FIG. 5.

### Management of Caption Setting

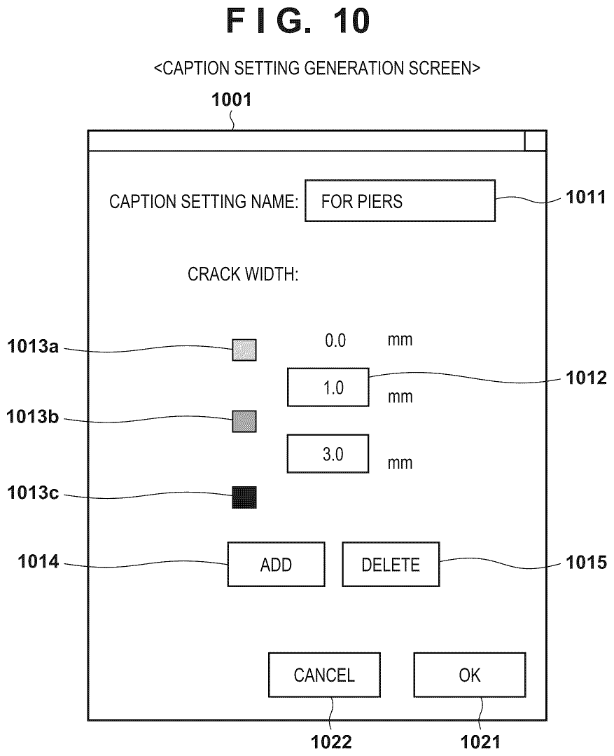

When the new caption setting generation button 332 in the caption setting list area 304 on the list screen 301 of FIG. 3 has been operated, a screen for newly generating a caption setting to be applied to the folder is displayed. Here, the caption setting generation screen according to the present embodiment will be described with reference to FIG. 10.

FIG. 10 is a diagram exemplarily showing the caption setting generation screen according to the present embodiment. The caption setting generation screen 1001 includes a caption setting name input field 1011, crack width category value input fields 1012, and rendering color display setting fields 1013. The caption setting generation screen 1001 also includes a crack width category level addition button 1014, a crack width category level reduction button 1015, an OK button 1021, and a cancel button 1022.

The user inputs a title that allows a target of application of the caption setting to be easily distinguished, such as a type of a structure, to the caption setting name input field 1011, and inputs values indicating how to categorize the crack widths in the analysis results of an inspection target to the crack width category value fields 1012. In the example of FIG. 10, “for piers” is input to indicate the type of the structure. Furthermore, the crack width category value fields 1012 of FIG. 10 exemplarily show that a first level of crack widths is equal to or larger than 0.0 mm and smaller than 1.0 mm, a second level is equal to or larger than 1.0 mm and smaller than 3.0 mm, and a third level is equal to or larger than 3.0 mm.

Furthermore, in the rendering color display setting fields 1013, rendering colors in which the respective levels of crack width categories are represented on an analysis result viewing screen 601, which will be described later, are selected. In the example illustrated in FIG. 10, 1013a indicates a rendering color for the first level of crack widths. Also, 1013b indicates a rendering color for the second level, and 1013c indicates a rendering color for the third level. Note that although the color-based distinction has been described as an example in the present embodiment, line types or another representation method may be used.

Also, the crack width category level addition button 1014 is a button for adding a new crack width category level to the caption setting generation screen 1001. Once a new crack level has been added, a crack width category value input field 1012 and a rendering color display setting field 1013 for the new level are added to the caption setting generation screen 1001.

Furthermore, the crack width category level reduction button 1015 is a button for reducing the crack width category levels that have already been set from the caption setting generation screen 1001. In a case where the crack width category levels are to be reduced, a crack width category level corresponding to a large numerical value may be removed each time the reduction button is pressed. Alternatively, the crack width category level reduction button 1015 may be provided for each level, and a crack width category level corresponding to the operated button may be removed.

The OK button 1021 is a button for deciding on the caption setting name input to the caption setting name 1011, the crack width values input to the crack width category value input fields 1012, and the rendering colors for the crack width category levels set in the rendering color display setting fields 1013, and for storing the caption setting. The cancel button 1022 is a button for cancelling the caption setting name input to the caption setting name 1011, the crack width values input to the crack width category value input fields 1012, and the rendering colors for the crack width category levels set in the rendering color display setting fields 1013. In response to pressing of the cancel button 1022, the input contents are cancelled, thereby returning to the list screen 301.

### Analysis Result List Screen and Analysis Result Viewing Screen

Next, the analysis result list screen and the analysis result viewing screen according to the present embodiment will be described with reference to FIG. 5 and FIG. 6.

FIG. 5 is a diagram exemplarily showing the analysis result list screen according to the present embodiment. The analysis result list screen 501 can be configured as a screen on which the image list area 303 of the list screen 301 has been replaced with an analysis result list area 502; thus, a description of elements that are similar to those on the list screen 301 is omitted. Note that no limitation is intended by this configuration.

In the analysis result list area 502, an analysis result list 512 representing the results of execution of image analysis with respect to the image files checked in the image list 322 of FIG. 3, an image list tab 511a, and an analysis result list tab 511b are displayed. The user can display the image list area 303 of FIG. 3 by operating the image list tab 511a.

The analysis result list 512 displays analysis complete, being analyzed, or analysis failed as a status of image analysis, together with a memo for the execution that was input for the execution of analysis; a view button 513 and a download button 514 are displayed for each analysis result. When the view button 513 has been operated in relation to a desired analysis result in the analysis result list 512, the analysis result viewing screen 601 shown in FIG. 6 is displayed. Also, when the download button 514 has been operated, a data file of a defect detected through the image analysis is downloaded from an external server. In this way, the analysis result can be provided through screen display and/or downloading of data.

FIG. 6 is a diagram exemplarily showing the analysis result viewing screen according to the present embodiment. The analysis result viewing screen 601 displays a folder name 611a, a memo for execution 611b, an analysis result display field 612, a caption display field 613, and a return button 614. The folder name 611a shows a folder name with which an image file that has undergone the executed image analysis has been registered, whereas the memo for execution 611b shows a memo for the execution.

The analysis result display field 612 displays analysis results 621 of cracks or the like as defects detected through the image analysis (e.g., lines indicating the defects such as cracks) in such a manner that they are superimposed on an inspection target image. A line indicating a crack includes actual size information related to the length and thickness (width), and is displayed so that it can be identified based on a display format (e.g., a display color or a line type) that varies in accordance with the length and thickness (width) of the crack.

The caption display field 613 displays correspondence between actual size information related to the widths (thicknesses) of cracks and display formats. The actual size information related to the lengths and thicknesses (widths) of cracks can be calculated from the image resolution and the number of pixels in the image. Also, the coordinates of the analysis results are converted into numerical values that conform with the coordinate system of a plan by cross-referencing the actual size information of the cracks with data of the plan; in this way, viewing and editing on the image analysis apparatus or an external server become possible.

Furthermore, the user can display the analysis result list screen 501 shown in FIG. 5 by operating the return button 614 on the analysis result viewing screen 601.

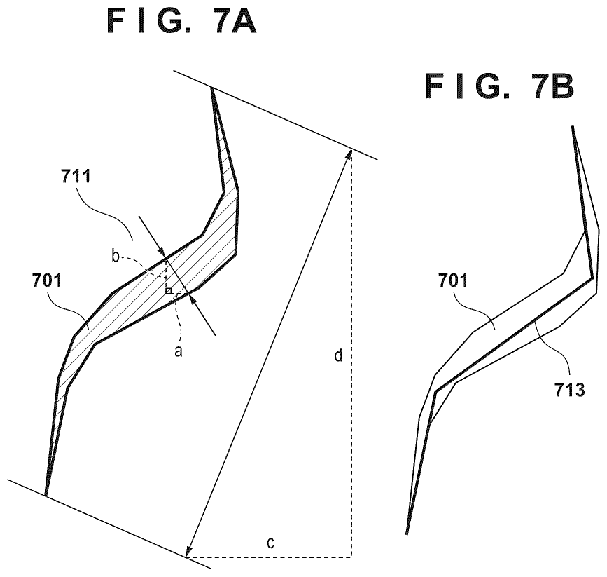

Here, FIG. 7A and FIG. 7B are diagrams illustrating a method of calculating actual size information of a crack from the image resolution and the number of pixels in an image according to the present embodiment. FIG. 7A is a diagram illustrating a calculation method that approximates a crack by a straight line. FIG. 7B is a diagram illustrating a calculation method that approximates a crack by a broken line.

Regarding a crack 701 shown in FIG. 7A, the thickness (width) 711 of the crack is the actual size information to be obtained. As the thickness (width) 711 of the crack has an area along a diagonal direction in an inspection target image, it is calculated from the horizontal and vertical lengths. Provided that the image resolution of the image corresponding to the thickness (width) 711 of the crack is k, the number of pixels in the horizontal direction is a, and the number of pixels in the vertical direction is b, the actual size information can be calculated from the following approximation formula 1 based on a straight line.

k×√(a×a+b×b) (formula 1)

A length 712 of the crack can be similarly calculated by, in formula 1, substituting the number of pixels c in the horizontal direction and the number of pixels d in the vertical direction, which correspond to the length 712 of the crack, for the number of pixels a in the horizontal direction and the number of pixels b in the vertical direction, which correspond to the thickness (width) 711 of the crack. Note that in the case of a curved crack, which is not suitable for the approximation by a straight line, it is possible to approximate the crack 701 by a plurality of straight lines in a broken line 713 as shown in FIG. 7B, and calculate a sum total of the lengths of the respective straight lines in the broken line 713.

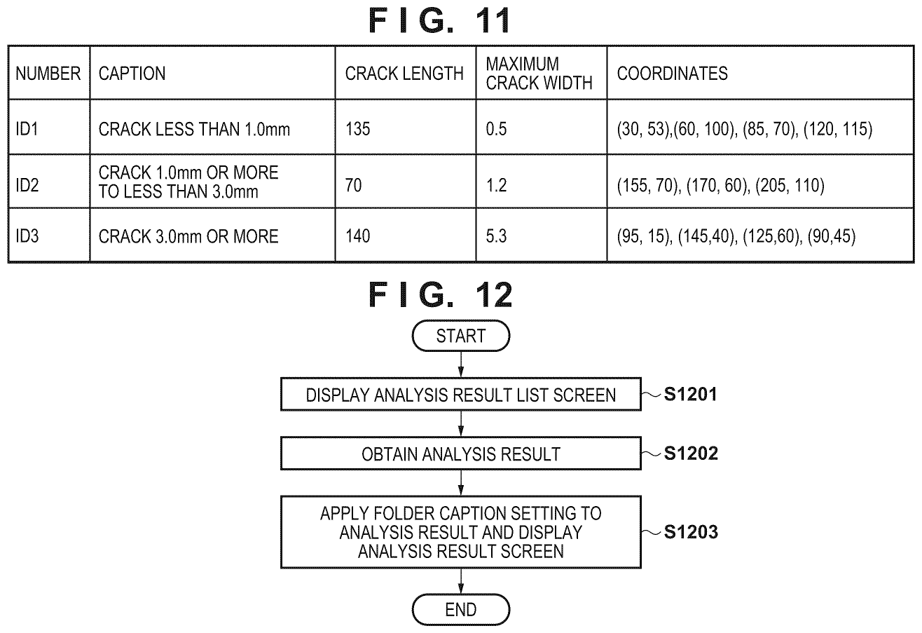

Also, FIG. 11 is a diagram exemplarily showing the substances of data files of defects that can be obtained through downloading according to the present embodiment. These are data showing a list of data pieces indicating defects detected through image analysis; here, there are numbers, captions, crack lengths, maximum crack widths, and coordinates. For example, regarding number=ID1, caption=crack smaller than 1.0 mm, crack length=135, maximum crack width 0.5, and coordinates=(30, 53), (60, 100), (85, 70), and (120, 115). Regarding number=ID2, caption=crack equal to or larger than 1.0 mm and smaller than 3.0 mm, crack length=70, maximum crack width 1.2, and coordinates=(155, 70), (170, 60), and (205, 110). Regarding number=ID3, caption=crack equal to or larger than 3.0 mm, crack length=140, maximum crack width 5.3, and coordinates=(95, 15), (145, 40), (125, 60), and (90, 45).

The caption setting that has been set for the folder in the foregoing manner may be not only displayed on the analysis result viewing screen, but also reflected in a data file that is output as the analysis result. Processing for the reflection at the time of analysis will be described using a later-described flowchart.

### Processing for Executing Image Analysis

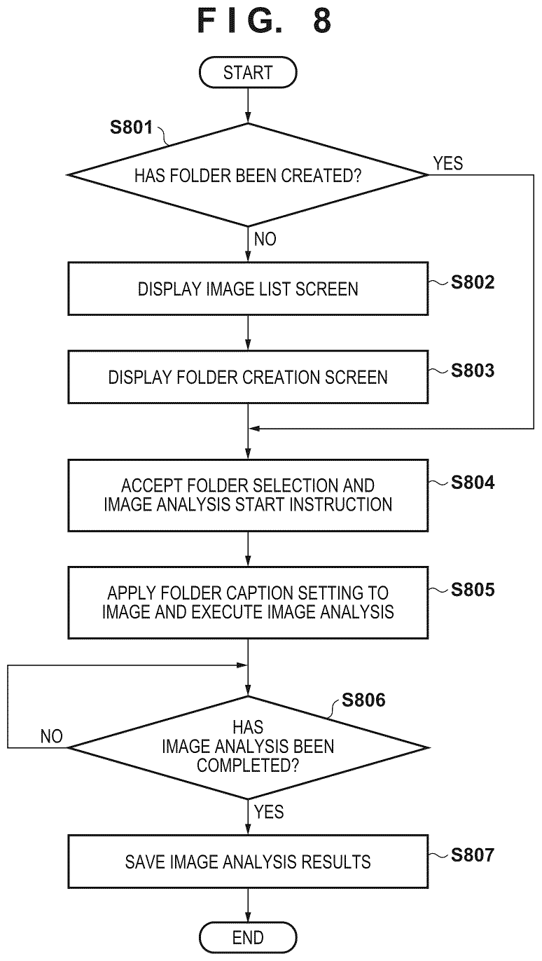

Next, a procedure of processing for executing image analysis on the image analysis apparatus according to the present embodiment will be described with reference to a flowchart of FIG. 8. The processing of FIG. 8 is realized by the control unit 101 of the image analysis apparatus 100 shown in FIG. 1 executing the functions shown in FIG. 2 by deploying the program stored in the nonvolatile memory 102 to the working memory 103, executing the program, and controlling each constituent element.

In step S801, the folder management unit 211 determines whether a folder with which an inspection target image has been register has already been created. In a case where the folder management unit 211 has determined that the folder has already been created, processing proceeds to step S804. On the other hand, in a case where the folder management unit 211 has determined that the folder has not already been created, processing proceeds to step S802.

In step S802, the folder management unit 211 displays the list screen 301 shown in FIG. 3 on the output device 106. Then, an operation on the new folder creation button 312 is accepted.

In step S803, the folder management unit 211 displays the folder creation screen 401 shown in FIG. 4 on the output device 106. Then, inputs to the folder name input field 411, the image resolution input field 412, and the caption setting selection field 413 are accepted.

Also, upon accepting an operation on the OK button 421, the folder management unit 211 newly creates the folder, and stores the settings of the folder name, the image resolution, and the caption setting of the newly created folder into the folder setting storage unit 212. In this way, the caption setting is applied to the folder targeted for the execution of the image analysis and viewing of the analysis results; consequently, the caption setting applied to the folder can be applied when executing the image analysis, when storing the analysis results, and when viewing the analysis results with respect to the images inside the folder.

In step S804, the folder management unit 211 displays the list screen 301 shown in FIG. 3 on the output device 106, and accepts a selection of a folder via a user operation. The newly created folder may be selected, or a folder may be selected from among one or more other folders that already exist. Then, an operation of checking desired image files inside the selected folder and an operation on the analysis start button 324 are accepted via a user operation.

In step S805, upon accepting an operation on the analysis start button 324, the image analysis unit 215 executes the image analysis with respect to the images that have been checked among the images inside the folder, in accordance with the caption setting of the folder selected by the user. For example, in a case where the caption setting of the selected folder includes an image analysis condition for piers, image analysis for piers is executed. Also, in a case where the caption setting of the selected folder includes an image analysis condition for tunnels, image analysis for tunnels is executed. In this way, the caption setting to be applied to the image analysis is set for the folder targeted for the execution of the analysis; consequently, when executing the image analysis, the caption setting applied to the folder can be applied to the analysis of designated images inside the folder.

In step S806, the image analysis unit 215 determines whether the image analysis has been completed. In a case where the image analysis unit 215 has determined that the image analysis has been completed, processing proceeds to step S808. On the other hand, in a case where the image analysis unit 215 has determined that the image analysis has not been completed, processing returns to step S806. In step S807, the analysis result storage unit 217 stores image analysis results. This marks the end of the processing sequence of FIG. 8.

### Processing for Viewing Image Analysis Results

Next, a procedure of processing for viewing the results of analysis executed by the image analysis apparatus according to the present embodiment will be described with reference to a flowchart of FIG. 12. The processing of FIG. 12 is realized by the control unit 101 of the image analysis apparatus 100 shown in FIG. 1 executing the functions shown in FIG. 2 by deploying the program stored in the nonvolatile memory 102 to the working memory 103, executing the program, and controlling each constituent element.

In step S1201, upon accepting an operation on the analysis result list tab 321b of the list screen 301 shown in FIG. 3, the analysis result management unit 216 displays the analysis result list screen 501 shown in FIG. 5 on the output device 106. In step S1202, the analysis result management unit 216 accepts an operation on the view button 513 for a desired analysis result. Then, the analysis result management unit 216 obtains the analysis result stored in the analysis result storage unit 217.

In step S1203, the analysis result management unit 216 applies the caption setting of the settings for the folder, which have been stored in the folder setting storage unit 212, to the image analysis result, and displays the analysis result viewing screen 601. That is to say, the analysis result is displayed on the screen in a display format based on the caption setting applied to the folder (e.g., the category of the defect based on the caption setting, the rendering color and the rendering line type of the defect corresponding to the pertinent category, and the like). This marks the end of the processing sequence of FIG. 12.

As described above, according to the present embodiment, a caption setting is applied to a folder with which an inspection target image is to be registered and for which the analysis is to be executed. In this way, when executing the image analysis and viewing the analysis results, the caption setting applied to the folder can be applied to the analysis of every image inside the folder (or designated images inside the folder) and provision of the analysis results.

Also, as there is no need to manually apply the caption setting with respect to each individual image analysis of an inspection target, an operational burden for applying the caption setting at the time of the image analysis of the inspection target can be alleviated. Furthermore, as there is no need to manually apply the caption setting with respect to each individual analysis result of the inspection target, an operational burden for applying the caption setting to the image analysis results of the inspection target can be alleviated.

### Second Embodiment

The first embodiment has been described using an example in which image analysis is executed while automatically reflecting a caption setting of a folder at the time of the execution of the image analysis. In contrast, a second embodiment will be described using an example in which a user temporarily changes a caption setting.

### Image Analysis Method Selection Screen

FIG. 9 is a diagram exemplarily showing an image analysis method selection screen selection screen according to the present embodiment. In the present embodiment, when the analysis start button 324 has been operated on the list screen 301 shown in FIG. 3, an image analysis method selection screen 901 shown in FIG. 9 is displayed.

The image analysis method selection screen 901 includes a memo for execution input field 911, a learning model selection field 912, parameter input fields 913, a caption setting switching field 914, an OK button 921, and a cancel button 922.

When executing the analysis, a memo for the execution is freely input to the memo for execution input field 911 via a user operation, similarly to the first embodiment. A learning model that has been selected from among a plurality of learning models can be input to the learning model selection field 912. The user can select a learning model that is suitable for an inspection target from among a plurality of learning models registered with the learning model selection field 912. The plurality of learning models can include, for example, a general-purpose AI model, an AI model for piers, an AI model for tunnels, and so forth.

Parameters to be provided to the learning model, such as the image resolution, can be input to the parameter input fields 913. Also, a plurality of (e.g., three types of) parameters can be input for each of the learning models that can be selected in the learning model selection field 912. A caption setting selected from among a plurality of caption settings for piers, for tunnels, and the like can be input to the caption setting switching field 914.

The OK button 921 is a button for deciding on the memo for the execution that has been input to the memo for execution input field 911, the learning model selected via the learning model selection field 912, one or more parameters that have been input to the parameter input fields 913, and the caption setting that has been input to the caption setting switching field 914. In response to pressing of the OK button 921, the settings of the image analysis method are stored. The cancel button 922 is a button for cancelling the memo for the execution that has been input to the memo for execution input field 911, the learning model selected via the learning model selection field 912, one or more parameters that have been input to the parameter input fields 913, and the caption setting that has been input to the caption setting switching field 914. In response to pressing of the cancel button 922, the input contents are cancelled, thereby allowing the inputs to be re-made.

The learning models have been trained in advance with use of images of specific inspection targets; therefore, with a user's selection of a learning model that is suitable for an inspection target, an improvement in the accuracy can be expected. Furthermore, it is also possible to improve the inspection by comparing the analysis results obtained by changing the parameters in the same learning model, or by preparing and incorporating a learning model that conforms with the user's environment.

As described above, according to the present embodiment, the user can temporarily change a caption setting, thereby allowing image analysis to be executed under a more appropriate analysis condition.

Note that although the present embodiment has been described using an example in which the user manually selects an image analysis method and a caption setting on the image analysis method selection screen 901, it is permissible to adopt a configuration in which the image analysis apparatus selects them automatically. This can reduce troubles of tasks. For example, it is possible to make use of an action of inputting the memo for the execution, before selecting a learning model and a caption setting, on the image analysis method selection screen 901. For example, it is permissible to adopt a configuration in which, in a case where the memo for execution input field 911 includes a term such as “pier” and “bridge”, the “learning model for piers” and the caption setting “for piers” may be automatically placed in a selected state as recommended options, and the user is allowed to change them later.

Furthermore, regarding an analysis result obtained by executing the image analysis while temporarily using a setting that is different from the caption setting set for the folder at the time of the image analysis in accordance with the present embodiment, such an analysis result may be displayed in the analysis result list 512 on the list screen 501 in such a manner that it is distinguishable from other analysis results.

### Modification Examples

The above embodiments have been described in relation to a case where defects are cracks. On the other hand, defects detected from an image may include regional defects that are other than cracks and do not have crack widths, such as exposed steel bars and efflorescence. In this case, a caption setting may be configured to include a rendering color display setting field for each defect. That is to say, the caption setting may include a category based on the regional defect (e.g., efflorescence or exposed steel bars) and a setting of a rendering element (e.g., a rendering color) corresponding to the pertinent category.

Also, the above embodiments have been described under the assumption that any rendering color display setting can be configured using the rendering color display setting fields 1013 shown in FIG. 10. On the other hand, control may be performed so that a user cannot make changes with regard to a predetermined defect. For example, it is permissible to adopt a configuration in which changing of a rendering color is not accepted with respect to a level of a predetermined category. Furthermore, it is permissible to adopt a configuration in which changing of rendering colors in which the levels of the respective categories are represented is not accepted with respect to a predetermined defect. In addition, control may be performed to block a user from changing a level of a specific crack width. Moreover, these may be combined.

Also, the above embodiments have been described under the assumption that a caption setting is applied when executing analysis and when viewing the results. Furthermore, control may be performed to disable changing of a caption setting after a folder has been created so as to prevent the occurrence of differences between a caption setting applied to a data file generated at the time of the analysis and a caption setting applied to the analysis results displayed at the time of viewing.

Also, the above embodiments have been described in relation to a case where a user generates a caption setting. On the other hand, common caption settings that have a possibility of being used by all users may be set in advance, and the caption settings may be made usable without users generating them on their own.

Also, although the above embodiments have been described using an example in which an image registered with a folder is a composite image, individual images before the composition may be registered as is.

Also, the above embodiments have been described in relation to a case where the categorization is performed based on crack widths when defects are cracks. On the other hand, it is permissible to detect a crack which is detectable as a crack but whose width cannot be distinguished because of, for example, deposition of efflorescence on the crack. In this case, display may be performed without performing the categorization based on crack widths. In this case, an image on which a line indicating the crack is superimposed may be provided without performing the categorization based on crack widths. In this case, the crack may be treated as a defect that is different from a normal crack, such as a crack accompanied by efflorescence in particular.

Also, although the above has described an example in which a caption setting for piers or for tunnels is selected from the caption setting selection field 413 on the folder creation screen 401 of FIG. 4, no limitation is intended by this. It is permissible to adopt a configuration in which a selection of an AI model to be applied to images inside a folder at the time of image analysis is further accepted, similarly to the image analysis method selection screen 901 shown in FIG. 9.

The present disclosure can alleviate a load at the time of image analysis.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-105341, filed Jun. 27, 2023, which is hereby incorporated by reference herein in its entirety.

What is claimed is:

1. An image analysis apparatus that analyzes an image of an inspection target, comprising:
a selection unit configured to select a folder; and
an analysis unit configured to analyze an image inside the folder selected by the selection unit based on a caption setting applied to the folder.

2. The image analysis apparatus according to claim 1, wherein
the selection unit selects a folder that has been selected by a user.

3. The image analysis apparatus according to claim 1, further comprising
a provision unit configured to provide an analysis result achieved by the analysis unit based on the caption setting applied to the folder selected by the selection unit.

4. The image analysis apparatus according to claim 3, wherein
the provision unit provides the analysis result by displaying the analysis result on a screen.

5. The image analysis apparatus according to claim 3, wherein
the provision unit provides the analysis result by downloading a file including the analysis result.

6. The image analysis apparatus according to claim 3, wherein
the analysis result is an image in which a line indicating a defect in the inspection target is superimposed on an image including the defect.

7. The image analysis apparatus according to claim 6, wherein
the defect includes a crack defect, and
the provision unit provides the image in which the line is superimposed in a display format that varies in accordance with categorization based on a crack width of the crack defect.

8. The image analysis apparatus according to claim 7, wherein
in a case where the crack width is not distinguishable, the provision unit provides the image in which the line is superimposed without performing the categorization based on the crack width.

9. The image analysis apparatus according to claim 1, further comprising
a folder creation unit configured to create a folder,
wherein the folder creation unit accepts, via a folder creation screen, an input of a folder name, an input of an image resolution to be applied to an image inside the folder, and a selection of a caption setting to be applied to the image inside the folder.

10. The image analysis apparatus according to claim 9, wherein
the folder creation unit accepts a selection of a caption setting that has been selected by a user from among a plurality of caption settings that have been registered in advance.

11. The image analysis apparatus according to claim 9, wherein
after creating a folder, the folder creation unit does not accept changing of a caption setting for the folder.

12. The image analysis apparatus according to claim 1, further comprising
a caption setting generation unit configured to generate a caption setting,
wherein the caption setting generation unit accepts, via a caption setting generation screen, an input of a caption setting name, an input of a category value for categorizing a defect in the inspection target, and a selection of rendering colors in which levels of respective categories are represented.

13. The image analysis apparatus according to claim 12, wherein
with regard to a level of a predetermined category, the caption setting generation unit does not accept changing of a rendering color.

14. The image analysis apparatus according to claim 12, wherein
with regard to a predetermined defect, the caption setting generation unit does not accept changing of the rendering colors in which the levels of the respective categories are represented.

15. The image analysis apparatus according to claim 1, further comprising
an acceptance unit configured to, when the analysis unit executes image analysis, accept a change to a caption setting different from the caption setting that has already been applied to the folder,
wherein the analysis unit executes the analysis while applying the changed caption setting to the folder.

16. The image analysis apparatus according to claim 15, further comprising
a provision unit configured to provide an analysis result achieved by the analysis unit based on the caption setting applied to the folder selected by the selection unit,
wherein in a case where the change to the different caption setting has been accepted, the provision unit provides the analysis result so that the analysis result is distinguishable from other analysis results.

17. The image analysis apparatus according to claim 1, wherein
the caption setting includes a setting of a rendering element for display of a defect in the inspection target detected through image analysis.

18. The image analysis apparatus according to claim 17, wherein
the caption setting includes categories based on a crack width of a crack defect in the inspection target, and settings of rendering elements that correspond to the respective categories.

19. The image analysis apparatus according to claim 18, wherein
the caption setting includes categories based on a regional detect in the inspection target, and settings of rendering elements that correspond to the respective categories.

20. The image analysis apparatus according to claim 1, wherein
the caption setting includes an analysis condition corresponding to a type of a structure that is the inspection target.

21. A control method for an image analysis apparatus that analyzes an image of an inspection target, comprising:
selecting a folder; and
analyzing an image inside the folder selected in the selecting based on a caption setting applied to the folder.

22. A non-transitory computer-readable storage medium storing a program for causing a computer to execute a control method for an image analysis apparatus that analyzes an image of an inspection target, the control method for the image analysis apparatus comprising:
selecting a folder, and
analyzing an image inside the folder selected in the selecting based on a caption setting applied to the folder.
